(19) United States
(12) Patent Application Publication
(10) Pub. No.: US 2021/0409981 A1
(43) Pub. Date: Dec. 30, 2021

(54) ADAPTIVE NETWORK DATA COLLECTION AND COMPOSITION

(71) Applicant: XIDIAN UNIVERSITY, Xi'an, Shaanxi (CN)

(72) Inventors: Zheng Yan, Xi'an, Shaanxi (CN); Huaqing Lin, Xi'an, Shaanxi (CN); Yulong Fu, Xían, Shaanxi (CN)

(21) Appl. No.: 16/614,187

(22) PCT Filed: May 18, 2017
(86) PCT No.: PCT/CN2017/084921

§ 371 Date: Nov. 15, 2019

(51) Int. Cl. H04W 24/08; H04L 12/26; H04L 29/06; H04W 12/122

(52) U.S. Cl. CPC H04W 24/08; H04L 43/028; H04L 43/04; H04W 12/122; H04L 63/205; H04L 63/1425; H04L 43/024

(57) ABSTRACT

A method for adaptive data collection is proposed. The method may comprise detecting a network context for a communication node, and collecting network data for the communication node based at least in part on policy information associated with the network context. The policy information may describe a collection policy for the network data. According to an exemplary embodiment, the method may further comprise transmitting at least part of the collected network data and a tag derived from the policy information to a server for data composition.

### FIELD OF THE INVENTION

The present disclosure generally relates to communication networks, and more specifically, relates to data collection of the communication networks.

### BACKGROUND

This section introduces aspects that may facilitate a better understanding of the disclosure. Accordingly, the statements of this section are to be read in this light and are not to be understood as admissions about what is in the prior art or what is not in the prior art.

Communication service providers and network operators have been continually facing challenges to deliver value and convenience to consumers by, for example, providing compelling network services and performances. With the rapid development of networking and communication technologies, more and more attention has been paid to the security of a network system, especially a heterogeneous network system that is organized by different types of networks, such as the Internet, mobile cellular networks, self-organized Mobile Ad hoc Networks (MANET), Wireless Sensor Networks (WSN), etc. The network security is usually reflected by relevant data in the network system. By studying the data related to network security events, the security of the network system can be quantified and measured.

### SUMMARY

This summary is provided to introduce a selection of concepts in a simplified form that are further described below in detailed description. This summary is not intended to identify key features or essential features of the claimed subject matter, nor is it intended to be used to limit the scope of the claimed subject matter.

With the development of the next generation mobile networks and wireless systems such as 5G or new radio (NR), a large number of complex networks are integrated to form a heterogeneous network system. For the heterogeneous network system, it may be desirable to collect and compose network data in various network environments adaptively and non-destructively.

The present disclosure proposes a solution of adaptive network data collection and composition, which can enable the network data to be processed and analyzed according to different network contexts, so that a credible and efficient system measurement (especially about network security) may be performed with the network data in a heterogeneous network environment.

According to a first aspect of the present disclosure, there is provided a method implemented at a communication node. The method may comprise detecting a network context for a communication node and collecting network data for the communication node based at least in part on policy information associated with the network context. The policy information may describe a collection policy for the network data. The method may further comprise transmitting at least part of the collected network data and a tag derived from the policy information to a server for data composition.

In accordance with some exemplary embodiments, the policy information may indicate one or more instructions for pre-processing the collected network data to obtain the at least part of the collected network data.

According to a second aspect of the present disclosure, there is provided an apparatus such as a communication node. The apparatus may comprise one or more processors and one or more memories comprising computer program codes. The one or more memories and the computer program codes may be configured to, with the one or more processors, cause the apparatus at least to perform any step of the method according to the first aspect of the present disclosure.

According to a third aspect of the present disclosure, there is provided a computer program product comprising a computer-readable medium bearing computer program codes embodied therein for use with a computer. The computer program codes may comprise code for performing any step of the method according to the first aspect of the present disclosure.

According to a fourth aspect of the present disclosure, there is provided an apparatus such as a communication node. The apparatus may comprise a detecting module, a collecting module and a transmitting module. In accordance with some exemplary embodiments, the detecting module may be operable to carry out at least the detecting step of the method according to the first aspect of the present disclosure. The collecting module may be operable to carry out at least the collecting step of the method according to the first aspect of the present disclosure. The transmitting module may be operable to carry out at least the transmitting step of the method according to the first aspect of the present disclosure.

According to a fifth aspect of the present disclosure, there is provided a method implemented at a server. The server may perform data composition and system measurement. The method may comprise receiving network data and a tag at a server. The network data may be collected for a communication node based at least in part on policy information associated with a network context of the communication node. The policy information may describe a collection policy for the network data and the tag may be derived from the policy information. The method may further comprise performing data composition of the network data based at least in part on the tag.

In accordance with some exemplary embodiments, said performing data composition of the network data based at least in part on the tag may comprise: applying one or more processing algorithms indicated by the tag to the network data; and aggregating respective outputs of the one or more processing algorithms to obtain a result of the data composition.

In accordance with some exemplary embodiments, the network data may comprise security-related data. The method according to the fifth aspect of the present disclosure may further comprise measuring a security level for a network with the network context based at least in part on the security-related data and the tag.

According to a sixth aspect of the present disclosure, there is provided an apparatus such as a server. The apparatus may comprise one or more processors and one or more memories comprising computer program codes. The one or more memories and the computer program codes may be configured to, with the one or more processors, cause the apparatus at least to perform any step of the method according to the fifth aspect of the present disclosure.

According to a seventh aspect of the present disclosure, there is provided a computer program product comprising a computer-readable medium bearing computer program codes embodied therein for use with a computer. The computer program codes may comprise code for performing any step of the method according to the fifth aspect of the present disclosure.

According to an eighth aspect of the present disclosure, there is provided an apparatus such as a server. The apparatus may comprise a receiving module and a performing module. In accordance with some exemplary embodiments, the receiving module may be operable to carry out at least the receiving step of the method according to the fifth aspect of the present disclosure. The performing module may be operable to carry out at least the performing step of the method according to the fifth aspect of the present disclosure.

Optionally, the apparatus according to the eighth aspect of the present disclosure may further comprise a measuring module. In accordance with some exemplary embodiments, the measuring module may be operable to carry out at least the measuring step of the method according to the fifth aspect of the present disclosure.

In accordance with some exemplary embodiments, the collection policy may indicate one or more collection schemes for the network data according to a category of the network data.

In accordance with some exemplary embodiments, the tag may be attached to the network data as metadata. For example, the tag may indicate one or more data composition algorithms for the network data.

In accordance with some exemplary embodiments, the tag may indicate one or more security threats related to the network data. Optionally, the tag may indicate collection time of the network data.

In accordance with some exemplary embodiments, the policy information may be described in a markup language. For example, the policy information may comprise at least one of the following information elements for the network data: a network type, a network protocol, a data location, a data category, a data importance level, a collection priority, a data length, a storage type, a collector identification, and a composition tag.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIG. 1 is a flowchart illustrating a method according to an embodiment of the present disclosure;

FIG. 2 is a flowchart illustrating a method according to another embodiment of the present disclosure;

FIG. 3 is a system model according to an embodiment of the present disclosure;

FIG. 4 is a modular schematic diagram of a communication node according to an embodiment of the present disclosure;

FIG. 5 is a flowchart illustrating a procedure of adaptive data collection according to an embodiment of the present disclosure;

FIG. 6 is a flowchart illustrating a procedure of data composition for security measurement according to an embodiment of the present disclosure;

FIG. 7 is a block diagram illustrating an apparatus according to an embodiment of the present disclosure;

FIG. 8 is a block diagram illustrating another apparatus according to another embodiment of the present disclosure; and

FIG. 9 is a block diagram illustrating yet another apparatus according to a further embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication node” may refer to a terminal device in a communication network, or a network device via which the terminal device accesses to the communication network and receives services therefrom. The communication network herein may comprise a wired or wireless communication network.

The term “network device” may refer to a Base Station (BS), an Access Point (AP), a Mobile Management Entity (MME), Multi-cell/multicast Coordination Entity (MCE), a gateway, a controller or any other suitable network entity in the communication network. The BS may be, for example, a node B (NodeB or NB), an evolved NodeB (eNodeB or eNB), a next generation NodeB (gNodeB or gNB), a Remote Radio Unit (RRU), a Radio Header (RH), a Remote Radio Head (RRH), a relay, a low power node such as a femto, a pico, and so forth.

The term “terminal device” may refer to any end device that can access a communication network and receive services therefrom. By way of example and not limitation, the terminal device may refer to a mobile terminal, a User Equipment (UE), or other suitable user devices. The UE may be, for example, a subscriber station, a portable subscriber station, a Mobile Station (MS) or an Access Terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a Personal Digital Assistant (PDA), a vehicle, and the like.

The terminal device may support Device-to-Device (D2D) communications, for example by implementing a 3GPP standard for sidelink communication, and may in this case be referred to as a D2D communication device. As yet another specific example, in an Internet of Things (IoT) scenario, the terminal device may represent a machine or other device that performs monitoring and/or measurements, and transmits the results of such monitoring and/or measurements to another terminal device and/or a network equipment. The terminal device may in this case be a Machine-to-Machine (M2M) device or a Machine-Type Communication (MTC) device.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

As described previously, with the development of the communication systems, a large number of complex networks are integrated to form a heterogeneous network system. The heterogeneous network system has the following specific characteristics: a complicated topological network structure; a different network architecture from traditional networks; dynamic switching among different types of networks in an adaptive way; security-related data may be gigantic and have 5V characteristics (i.e., Volume, Velocity, Variety, Veracity and Value); more complicated network attacks than a single network; and so on.

For a heterogeneous network system, it may be necessary to collect some network data such as security-related data adaptively and non-destructively. Security-related data may refer to the data that indicate security threats and show abnormality with regard to security, safety, privacy and trust. By learning and analyzing these data, the intrusions and attacks of a network system may be detected to measure the security level of the whole network system.

The conventional data collection technology used in an intrusion detection system can realize real-time network system security monitoring and protection, but may be not proper for a heterogeneous network environment.

For example, a hardware based data collection method may use a hardware equipment to collect data from the network system, which is suitable for a large network system and has high performance. However, this method is cumbersome with high cost and not universal, for example, using a hardware probe to collect data. Network administrators often deploy a Simple Network Management Protocol (SNMP) in the network to collect security-related data. But this method cannot be applied to collect data in a network host terminal, and very complicated especially for mobile devices. In some application scenarios, port mirrors are deployed at router nodes, and when a user's device connects to the Internet through the router, the traffic data are mirrored into the collector server via the port mirrors. It is also a kind of data collection method, but it is not suitable for mobile devices because mobile devices have high mobility and this method is not flexible enough.

There are also some specific algorithms and mechanisms for network traffic collection. For example, according to the network data correlation and variation routines, a Two-Dimensional Adaptive Data Collection Method (TD-ADCM) is proposed to select the data collection content in association with network data variation, and adjust collection frequency based on the ratio of the data variation amplitude. It is also possible to introduce stratified random sampling technique of statistics and simple random sampling technique of statistics to the procedure of data collection of Intrusion Detection Systems (IDS), and provide a new data collection model for IDS. In order not to cause a significant burden on the network system and enhance the efficiency, a sampling method for data collection is also feasible. But the sampling method is not flexible enough for data collection in a heterogeneous network system because of the specific characteristics of the heterogeneous network system.

Obviously, the conventional data collection technology focuses on a single network system architecture, which suffers from the problem caused by dynamically switching connections among multiple types of network systems. Therefore, it may be desirable to design an adaptive solution of data collection for not only the single network system but also the heterogeneous network system.

The proposed solution of network data collection according to some exemplary embodiments of the present disclosure is universal, which can be pervasively applied at any communication nodes located in different network positions, such as routers, switches, network servers, Personal Computer (PC) hosts and network terminal nodes played by mobile or fixed devices. In addition to a single independent system, the proposed solution is also suitable for a heterogeneous network system.

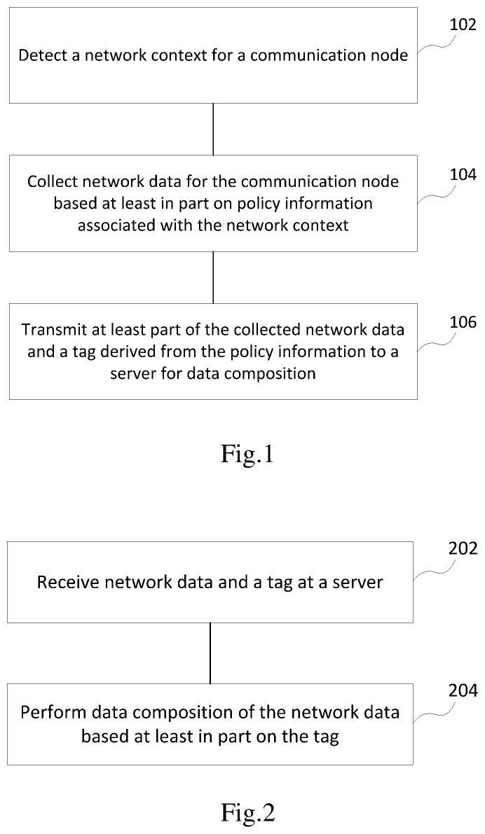

FIG. 1 is a flowchart illustrating a method according to an embodiment of the present disclosure. The method illustrated in FIG. 1 may be performed by an apparatus implemented at a communication node. The communication node may comprise a terminal device (such as a mobile station or a fixed terminal) or a network device (such as an access point or a network entity). The method may be applicable in a single network system or a heterogeneous network system for data collection and composition.

According to the exemplary method illustrated in FIG. 1, a network context for a communication node may be detected at block 102. The network context may indicate a type and/or an environment of a network in which the communication node is located. Different network contexts may be related to different network architectures and/or protocols. Accordingly, the detection of the network context may facilitate to determine what kind of data need to be collected and how to collect the data in the detected network context.

Based at least in part on policy information associated with the network context, network data for the communication node may be collected at block 104. The policy information may describe a collection policy for the network data. According to an exemplary embodiment, the collection policy may indicate one or more collection schemes for the network data according to a category of the network data. For example, the policy information may comprise some descriptive information of data type to indicate the category of the network data, which may be used in the classification for data processing and analytics.

In an exemplary embodiment, the policy information may comprise one or more collector identifications (IDs) to indicate respective collection schemes or methods to be used for data collection. The collector ID may be used to trigger a corresponding data collector or drive a concrete data collection application to collect the network data according to one or more specific instructions from the policy information.

As an example, the policy information may comprise at least one of the following information elements for the network data: a network type, a network protocol, a data location, a data category, a data importance level, a collection priority, a data length, a storage type, a collector ID and a composition tag. It will be realized that the policy information may comprise other information elements than these exemplary information elements. Thus, the policy information may describe which data would be collected, how to collect these data and how to use these data to assess network security, especially for a heterogeneous network system.

In accordance with an exemplary embodiment, the policy information may be described in a markup language. For example, the policy information may be recorded or stored in a file based on the markup language, such as eXtensible Markup Language (XML), HyperText Markup Language (HTML), JavaScript Object Notation (JSON), Yet Another Markup Language (YAML), eXtensible HyperText Markup Language (XHTML) or the like. Through network context detection, the policy information associated with the detected network context can be obtained from the corresponding markup language file to trigger an adaptive collection of the network data.

In an exemplary embodiment, the network data collected under the detected network context may comprise security-related data. In this case, the policy information associated with the network context may be described in a Security-related Data Description Language (SDDL). The SDDL may specify, for example, in an XML file, what kind of security-related data need to be collected in which way under which network context, and mark the tags about data processing algorithms and the target attacks that the collected data can be used to detect. To this regard, the SDDL is a generic, comprehensive and extensible solution for network data expression. In particular, the SDDL may be used to describe security-related data to be collected and instruct security-related data collection under a concrete network context.

Optionally, the policy information may indicate one or more instructions for cleaning or pre-processing the collected network data to remove part of the collected network data, such as unreliable data, noisy data, redundant data, stale data and/or the like. The network data collected at respective communication nodes may be used for system measurement and performance evaluation, for example, by composing and processing the collected network data at a server.

In accordance with the exemplary method illustrated in FIG. 1, the communication node can transmit at least part of the collected network data and a tag derived from the policy information to a server for data composition, as shown in block 106. For example, the tag may be derived by extracting information about data composition from the policy information. The information about data composition, which may be indicated by a composition tag described in SDDL, may specify one or more algorithms used to compose and process data and the security threats or attacks which could be detected. In order to ensure the security of the collected network data, the transmission of the at least part of the collected network data from the communication node to the server may be secured, for example, by applying an encryption algorithm.

In an exemplary embodiment, the tag derived from the policy information may indicate one or more data composition algorithms for the at least part of the collected network data. The tag may also indicate one or more security threats related to the at least part of the collected network data. Optionally, the tag may further indicate collection time of the network data. For example, data collection time and/or location can be inserted into the tag during data collection. According to an exemplary embodiment, the tag may be attached to the at least part of the collected network data, for example, as metadata thereof, and sent to the server for data composition or a data processor to process. With the information in the tag, the server or the data processor can know how to process the data, for example, using which algorithm to detect which security intrusions based on what input sequence to the algorithm.

Thus it can be seen that the method as illustrated in combination with FIG. 1 may be applicable for network data collection and composition in a single network system or a heterogeneous network system. In particular, the SDDL is designed to express how to collect the specified network data and how to use them to measure the security of the network system. According to an exemplary embodiment, the SDDL based on XML is applied to enable the adaptive security-related data collection and composition. It will be realized that the SDDL based on XML described herein is just an example. Other suitable data description languages may also be employed to implement the proposed methods.

In accordance with an exemplary embodiment, a number of collection components may be applied to alleviate the burden on the network system in the process of data collection. Optionally, a sampling scheme may be used in the process of data collection to ensure that the data collection is not destructive. Further, the proposed solution can achieve the purpose of network security measurement by detecting malicious network intrusions and attacks at the server based at least in part on the received network data from one or more communication nodes.

FIG. 2 is a flowchart illustrating a method according to another embodiment of the present disclosure. The method illustrated in FIG. 2 may be performed by an apparatus implemented at a server or any other entity which can realize the data composition in a single network system or a heterogeneous network system.

Corresponding to the steps of the exemplary method for data collection performed by a communication node as illustrated in FIG. 1, the apparatus such as a server may receive network data and a tag at block 202 of FIG. 2. The network data are collected for a communication node based at least in part on policy information associated with a network context of the communication node. As described with respect to FIG. 1, the policy information may describe a collection policy for the network data, and the tag may be derived from the policy information. For example, the collection policy may indicate one or more collection schemes and optionally composition schemes for the network data according to a category of the network data. Thus, the server may perform data composition of the network data based at least in part on the tag, as shown in block 204.

In an exemplary embodiment, the tag may be received as the metadata of the network data to instruct data processing and analysis. The main content of the tag may be extracted by the communication node during parsing the policy information, for example, in an XML file described in SDDL (which is also referred to as SDDL-XML file). The policy information can tell what kind of data need to be collected for which purpose (detect what security threats) by using which algorithms. Accordingly, the tag derived from the policy information may indicate one or more security threats related to the network data. Alternatively or additionally, the tag may indicate one or more data composition algorithms for the network data, so that the security level of the network system may be measured with the composed data. Optionally, data collection time and/or location may be saved inside the tag. Thus, according to the information specified in the tag, the server can know how to process the received network data.

In accordance with an exemplary embodiment, performing data composition of the network data based at least in part on the tag may comprise: applying one or more processing algorithms (such as data composition algorithms, data analysis algorithms and/or the like) indicated by the tag to the network data; and aggregating respective outputs of the one or more processing algorithms to obtain a result of the data composition.

The network data collected at respective communication nodes may comprise various data, such as security-related data, state data, environment data, operation data and/or the like. In an exemplary embodiment, the method as illustrated in combination with FIG. 2 may optionally further comprise measuring a security level for a network with the network context based at least in part on the security-related data and the tag. For example, the security level of the network may be measured through detecting security intrusions and threats of the network.

It can be seen that the proposed methods as illustrated with respect to FIGS. 1-2 can enhance the collection and composition of security-related data for not only a single network system but also a heterogeneous network system. In particular, the policy information associated with a certain network context can express or describe the network data to be collected (such as security-related data) in a complete, comprehensive and extendable way. In addition, an automatic, adaptive and pervasive data collection procedure may be triggered according to the policy information, for example in a SDDL-XML file. Further, a credible and efficient data composition and analysis may be performed based at least in part on the collected network data and the attached tag for the purpose of security measurement.

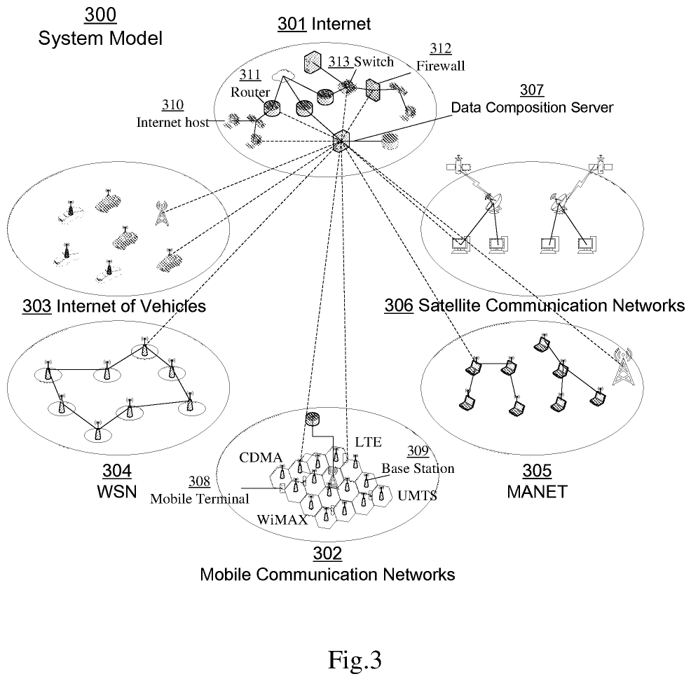

FIG. 3 is a system model according to an embodiment of the present disclosure. The system model 300 as shown in FIG. 3 supports various network systems, comprising the Internet 301, mobile communication networks 302, Internet of vehicles 303, WSN 30, MANET 305 and satellite communication networks 306. The mobile communication networks 302 may comprise various communication systems supporting suitable communication standards, such as Long Term Evolution (LTE), Code Division Multiple Access (CDMA), Worldwide Interoperability for Microwave Access (WiMAX), Universal Mobile Telecommunications System (UMTS) and etc. It will be realized that the network systems shown in FIG. 3 are just examples. The proposed solutions according to exemplary embodiments may also be applicable to other suitable network systems and communication environments.

The system model 300 may contain a data composition server 307 and a plurality of communication nodes such as mobile terminals 308, base stations 309, Internet hosts 310, routers 311, firewalls 312, switches 313 and/or the like. The communication node may install an adaptive data collector to collect data for network measurement. The collected data may be optionally pre-processed before transmitting to the data composition server 307. The data composition server 307 can realize composition of the collected data and perform the network system analytics and measurement. For example, the adaptive data collector can collect the security related data at respective communication nodes and transmit the security related data to the data composition server 307. With the security related data, the data composition server 307 can perform data composition, aggregation and processing, in order to detect security threats, intrusions and attacks, thus measure the security of the network system accordingly.

In an exemplary embodiment, a mobile terminal 308 equipped with an adaptive data collector can access multiple network systems, and thus can play as a communication node in various types of networks. In addition to a network terminal node such as the mobile terminal 308, the network data collection according to exemplary embodiments also may be carried out at any other network nodes, comprising a boundary network node, a core network node and so on. For example, in the Internet 301, the network data collection may be carried out not only for security-related data at an Internet host 310, but also for security-related data in a router 311, a firewall 312, a switch 313 and/or other nodes (e.g., in a control plane or a data plane in a software defined network).

In order to support relative complex network topologies and dynamic switching among multiple types of network systems in a heterogeneous network as shown in the system model 300, a scalable data description language such as SDDL may be designed for the adaptive and non-destructive data collection and composition in the heterogeneous network. This approach may facilitate the formation of a unified standard and model for expressing network security related data.

Different network contexts may suffer from different network attacks, and different network security-related data need to be collected for the purpose of security measurement of the heterogeneous network. According to an exemplary embodiment, the data that need to be collected in a specified network context may be expressed and described with the SDDL in an XML file corresponding to the specified network context. Optionally, additional security-related data and data processing and analysis algorithms also can be added into the XML file to support newly advanced mechanisms for network security measurement. Thus, the XML file can be flexibly extended to contain descriptions on security-related data based on practical needs.

For example, the security-related data that need to be collected may be expressed or described in the SDDL based on XML as follows:

| | |
|---|---|
| 1 | <?xml version=“1.0” encoding=“utf-8”?> |
| 2 | <security-data> |

| | |
|---|---|
| 3 | <network-type name:=“internet” > |

| | |
|---|---|
| 4 | <network-protocol name:=“TCP” > |

| | |
|---|---|
| 5 | <data name:=“TTL” > |

| | |
|---|---|
| 6 | <data-location>64</data-location> |
| 7 | <data-category>5</data-category> |
| 8 | <data-importance-level>5</data-importance-level> |
| 9 | <collection-priority>1</collection-priority> |
| 10 | <data-length>8</data-length> |
| 11 | <data-type>int</data-type> |
| 12 | <collection-method>network_packet_collector</collection-method> |
| 13 | <processing-algorithm>algo_1</processing-algorithm> |
| 14 | <composition-tag>dos</composition-tag> |

| | |
|---|---|
| 15 | </data> |

In this example, Time To Live (TTL) is described as the network security-related data to be collected. TTL specifies the maximum number of segments allowed to pass before the Internet Protocol (IP) packet is discarded by a router. TTL is security-related data about network packets and it can be used to detect Denial-of-Service (DoS) attack or other network attacks. This kind of data can be collected by a network packet collector. It is noted that the network data which need to be collected are not limited to the security-related data such as TTL, but may comprise other types of network data.

According to an exemplary embodiment, in addition to the data name, other information elements also may be marked in the data description for the purpose of collection, such as data length, type, priority, location and etc. Here are some explanations of the exemplary information elements comprised in the SDDL based on XML:
network-type: the specific network context in which the indicated network data need to be collected;
network-protocol: the network protocol used in the network system;
data-location: the location of the network data;
data-category: the category of data which is used in the classification for data composition and analytics;
data-importance-level: the importance level of the data;
collection-priority: the priority of the data in the collection process;
data-length: the length of the data field;
data-type: the storage type of the data;
collection-method/collector ID: the identifier of the collection method or a corresponding data collector;
processing-algorithm: the algorithm used to process or pre-process the data;
composition-tag: a tag which indicates the security threats or attacks that could be detected with the collected data and the algorithms used to process the collected data, as well as collection time, etc.

By using these information elements, the SDDL can express the security-related data in a uniform way, and specify the data collection and composition dynamically and adaptively in a pervasive manner. For example, the value of the data field “collection-method/collector ID” may be used to trigger a data collector or drive a concrete data collection application. The larger the value of the data field “data-importance-level” is, the more important of the data for network security measurement. Some data indicated as important should be protected since it may relate to its owner's privacy. The higher the value of the data field “collection-priority” is, the higher the priority regarding data collection. On the other hand, the higher the importance level of security-related data is, the higher the possibility of the data to detect network intrusions, threats and attacks and the more useful for network security measurement, thus should be firstly collected if there is a tie of collection-priority. It will be appreciated that there may be other possible parameter settings for data fields of the information elements and the specific meaning thereof.

Further, the composition tag may be used to accurately call a specific algorithm to deal with the collected data to determine whether there is a specific threat or attack. For example, the main content of the tag as described in connection with FIGS. 1-2 may be extracted from the composition tag during parsing the SDDL-XML file, which tells what kind of data need to be collected for which purpose (for example, for detecting what security threats) by using which algorithms. Thus, the composition tag may form part of the metadata of the collected network security related data to instruct data processing and analysis.

Although the network data to be collected are marked by the SDDL based on XML in some exemplary embodiments, it is also possible to describe the network data with other types of languages, such as various data exchange and markup languages like XML, HTML, JSON, YAML, XHTML, etc. In practice, the selection of the descriptive language used to specify the network data may depend on system implementation preference and convenience.

According to an exemplary embodiment, the description of the network data and the policy information about data collection and/or composition may be located in an XML file expressed with SDDL. This XML file may be analyzed or parsed by a parser based at least in part on the detected network context associated with the XML file. The parsing result can provide the information of the data that need to be collected and the information of security data collectors. The information can play as an instructor to guide data collection (for example, with which data collectors to collect what data) and data composition (for example, with which algorithms to compose what data) in order to measure the security of the heterogeneous network.

Referring back to FIG. 3, the communication node, such as the mobile terminal 308, the base station 309, the Internet host 310 and/or the like, can detect a network context, for example, as a MANET node, a LTE base station, an Internet host and/or the like. Then the communication node can make the detected network context as an input of the parser to parse the SDDL, in order to figure out what kind of data needed to be collected in the underlying context and which data collectors needed to be driven to collect the data. As such, the communication node can do adaptive data collection based at least in part on the detected network context.

The communication node according to an exemplary embodiment of the present disclosure may comprise a network context detector, a policy information parser, at least one network data collector, a data transmitter, and optionally a data pre-processer. Specifically, the network context detector can detect the network context to determine the policy information associated with the detected network context. For example, the policy information may be located in an XML file corresponding to the detected network context, and the network context detector may cause this XML file to be chosen for processing.

The policy information parser, such as an XML parser, may be triggered by the network context detector and parse the specified policy information (for example, in an XML file) indicated by the network context detector to get a collection policy for the network data. The collection policy may be related to some information such as metadata of the security-related data that need to be collected. Based at least in part on the analysis of the policy information parser, one or more corresponding data collectors may be called to achieve data collection according to the policy information associated with the detected network context.

Optionally, the collected network data may be pre-processed at the data pre-processer. For example, the data pre-processer can initially clean the collected data to remove some undesired data. Then, the data transmitter can transmit the collected network data pre-processed by the data pre-processer to the server for data composition.

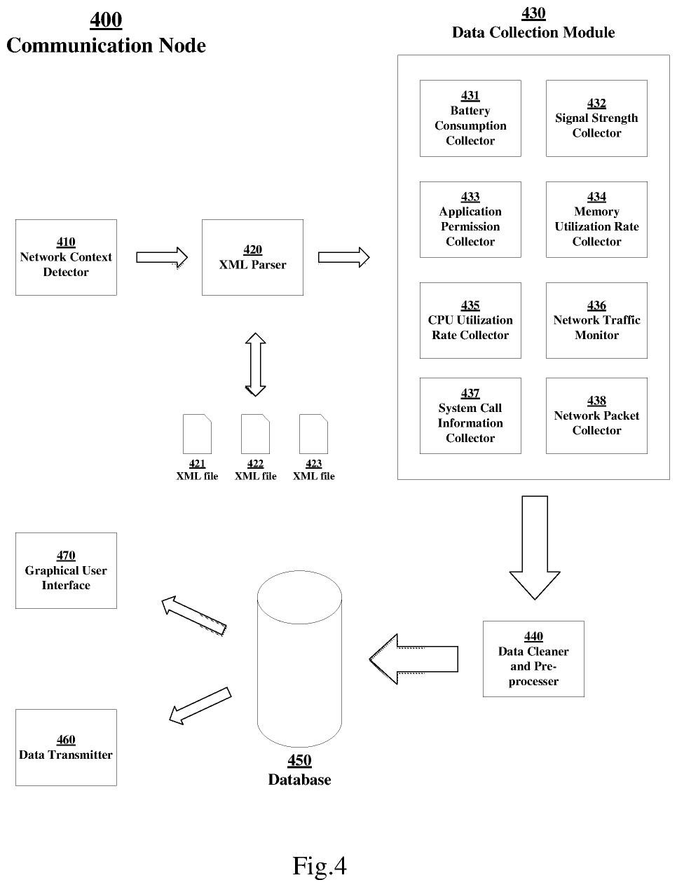

FIG. 4 is a modular schematic diagram of a communication node according to an embodiment of the present disclosure. As shown in FIG. 4, the communication node 400, such as a terminal device like a UE or a network device like a BS, may comprise a number of functional modules to perform the method as illustrated in FIG. 1. It will be realized that the communication node 400 may comprise more or less functional modules than those shown in FIG. 4, or optionally comprise other alternative functional modules, to facilitate the implementation of the proposed solution.

According to an exemplary embodiment, the communication node 400 may comprise a network context detector 410 which is responsible for the perception of network environment type and/or network context. The network data of different network contexts are different. For example, different network contexts may correspond to different security-related data expressed in SDDL. In order to reduce the size of the XML files expressed in SDDL, the XML files may be classified according to the network contexts. Thus, different network environments or contexts may correspond to different XML files 421, 422 and 423.

According to an exemplary embodiment, the communication node 400 may comprise a XML parser 420 which is responsible for parsing XML files 421, 422 and 423 corresponding to different network contexts. The XML parser 420 may trigger one or more data collectors of a data collection module 430 to collect different types of network data according to at least an instruction extracted from the specified XML file. The network data which need to be collected may comprise some security-related data, for example, battery consumption data, network traffic data, traffic package statistics, network signal strength data, application permission data, memory utilization rate, CPU utilization rate, system call information, etc.

According to an exemplary embodiment, the data collection module 430 may comprise one or more data collectors or data collection components, such as battery consumption collector 431, signal strength collector 432, application permission collector 433, memory utilization rate collector 434, CPU utilization rate collector 435, network traffic monitor 436, system call information collector 437, network packet collector 438, and/or the like. Alternatively or additionally, other data collectors also can be plugged or added in the data collection module 430 and the design of the communication node 400 may be extensible with the demand of practical needs. Accordingly, new data collectors can be deployed and corresponding component ID can be inserted into the policy information such as a SDDL-XML file.

With regard to the above exemplary data collectors, the battery consumption collector 431 is responsible for collecting the data about the battery power consumed by a device such as the communication node 400 or its component. The signal strength collector 432 is responsible for collecting network signal strength and its changes. For example, the network signal strength is often proportional to the network performance; otherwise it means that there may be a network intrusion, especially in WSN. The application permission collector 433 is responsible for collecting the data about resource access permissions of the applications installed in the device. The memory utilization rate collector 434 is responsible for collecting the memory utilization rate of any individual applications and/or the whole device. The CPU utilization rate collector 435 is responsible for collecting the CPU utilization rate of any individual applications and/or the whole device. The network traffic monitor 436 is responsible for collecting the data about inbound and outbound network traffic in a period of time. The system call information collector 437 is responsible for collecting the records about system function calls in the kernel of the device. The network packet collector 438 is responsible for capturing the network traffic data packets in the device.

In accordance with an exemplary embodiment, different kinds of security-related data may be divided into different levels according to their importance on network security measurement. For example, the battery consumption data may fall into the first importance level. The signal strength data and permission data of applications belong to the second importance level. Memory utilization rate and CPU utilization rate belong to the third importance level. Network flow statistical and system call information data belong to the fourth importance level. Network traffic packets data belong to the fifth importance level. According to an exemplary embodiment, the higher the importance level of security-related data is, the higher the possibility of the data to detect network intrusions and attacks and the more useful for network security measurement. The higher the importance level of security-related data is, the higher the priority of data collection.

Optionally, the communication node 400 may comprise a data cleaner and pre-processer 440 which is mainly responsible for cleaning and pre-processing the collected data in order to reduce the amount of data transmission to the composition server. For example, there may be some noisy data, redundant data or stale data in the process of the collected security-related data. So it may be required to clean up the useless data to improve the processing efficiency.

According to an exemplary embodiment, the communication node 400 may comprise a database 450 for storing the collected network data. The data stored in the database 450 can be transmitted to the composition server through a data transmission module such as a data transmitter 460, if needed. It will be realized that the collected network data also may be transmitted to the composition server without being stored at the database 450. The data transmitter 460 may be mainly responsible for data communication with the composition server. Optionally, the data transmitter 460 may support data transmission in a secure way by data encryption, in order to prevent data leakage and preserve data privacy during transmission and processing.

According to an exemplary embodiment, the communication node 400 may comprise a graphical user interface 470 to support interactions between the communication node 400 and its user. For example, the user of the communication node 400 can perform interactive operations with one or more data collectors of the data collection module 430 through the graphical user interface 470. For example, a process of data collection and/or its result may be provided to the user through the graphical user interface 470. The user can set and/or adjust the respective configurations of one or more data collectors through the graphical user interface 470 as required. Alternatively or additionally, the user may facilitate the addition or removal of one or more data collectors through the graphical user interface 470.

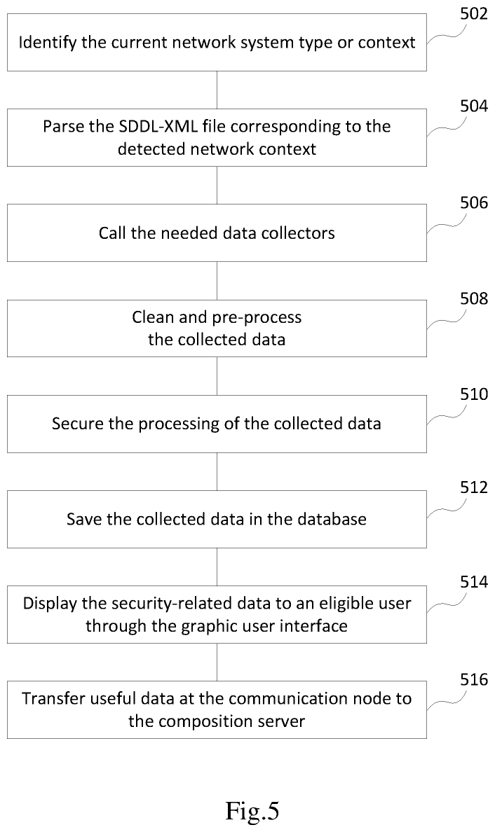

FIG. 5 is a flowchart illustrating a procedure of adaptive data collection according to an embodiment of the present disclosure. The procedure as shown in FIG. 5 may be performed at an apparatus such as the communication node 400 shown in FIG. 4. Although this procedure is illustrated in an example of security-related data, the exemplary procedure can be employed by various communication nodes located in different network positions to collect other useful network data.

As shown in FIG. 5, the network context detector can identify the current network system type or context at block 502, and trigger the XML parser to parse the SDDL-XML file corresponding to the detected network context at block 504. The SDDL-XML file may be managed by a network administrator based at least in part on the current advance of network threat and instruction detection theories.

Through parsing the SDDL-XML file, the XML parser may call the needed data collectors at block 506 to collect the security-related data under the instruction of SDDL-XML file. As mentioned in combination with FIG. 1, in addition to a collection policy for the security-related data, a tag about data composition and processing for network security analytics also can be extracted from the SDDL-XML file. The tag may be attached to each piece of collected data. For example, the same tag may be attached to the collected data which are indicated by the XML parser to collect. According to an exemplary embodiment, data collection time also can be added in the tag.

Optionally, the collected data may be cleaned and pre-processed at block 508 based at least in part on the instruction marked in the tag of the data. In order to preserve data security, the processing of the collected data may be secured at block 510. Alternatively or additionally, the collected data may be saved in the database at block 512, and the saved data may be encrypted and their access may be controlled. For example, the security-related data may be displayed to an eligible user through the graphic user interface, as shown in block 514.

Useful data at the communication node can be transferred to the composition server at block 516 to contribute to the security measurement of the whole network system. For example, according to the respective tags attached to each piece of collected data, the server would know how to compose the data using which algorithm to process and what kind of attacks and security threats could be detected. With the detection result, it is easy to figure out the security holes and measure the whole network system's security level.

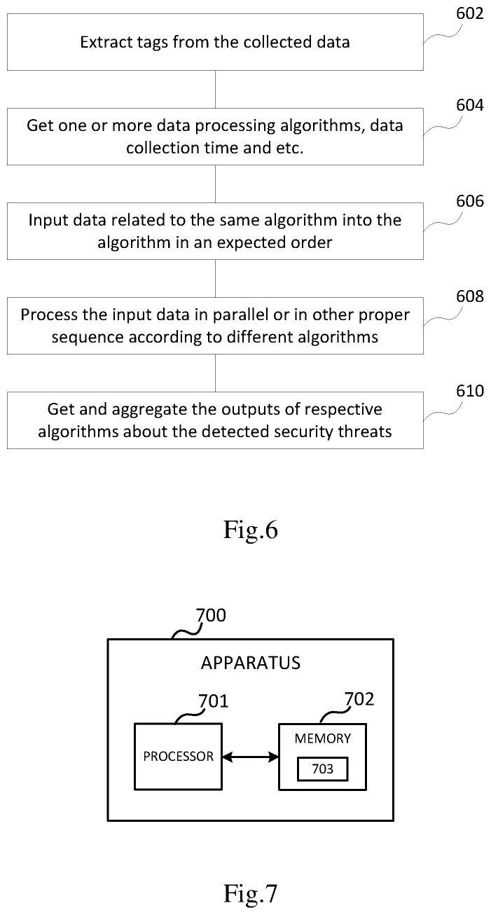

FIG. 6 is a flowchart illustrating a procedure of data composition for security measurement according to an embodiment of the present disclosure. The data composition for security measurement may be executed based at least in part on the tags attached to the collected security-related data. As shown in FIG. 6, tags may be extracted from the collected data at block 602 and used at block 604 to get one or more data processing algorithms, data collection time and so on. In other words, based on the extracted tags, it is easy to know which data composition and/or processing algorithm needs to be applied to process the collected data and what kind of security threats can be detected.

According to an exemplary embodiment, at least part of the collected data related to the same algorithm may be input into the algorithm in an expected order, as shown in block 606. The input data may be processed at block 608 in parallel or in other proper sequence according to different algorithms. The outputs of respective algorithms about the detected security threats can be got and aggregated at block 610 to measure the security level of the network system. For example, the security level of the network system may be decided by the risk level of detected security intrusions and threats. The higher the risk level, the lower the security level is.

The proposed solution as illustrated with respect to FIGS. 1-6 can enhance the adaptivity of the network data collection and composition, especially in a heterogeneous network system. Particularly, the data collection is adaptive to the network context and instructed by parsing an XML file expressed with SDDL. The collected data can be composed and processed based at least in part on the tags extracted from the SDDL-XML file and attached to the collected data.

Many advantages such as extendability, adaptability, non-destruction, simplicity and efficiency, and/or the like can be achieved by the proposed solution. As to the feature of extendability, SDDL can be flexibly upgraded and managed based on recent advance of network security measurement research and newly developed methods or algorithms. New data types can be introduced into the SDDL-XML file with its linked algorithms. New data collection components can be plugged into the system. The proposed solution can support embedding the description of new data type and new network intrusion/threat detection algorithms into the SDDL-XML file, thus support the related data collection and composition based on new methods and upgraded methods.

As to the feature of adaptability, the data collection can be driven by context detection. Through detecting the underlying network context and parsing the corresponding SDDL-XML file, the needed data collection components can be triggered to collect expected data for security measurement. Thus, the data collection is context-aware and adaptive to the network context.

As to the feature of non-destruction, a sampling method may be used to capture the network traffic, which does not generate additional burden and congestion to the network. Thus, the proposed solution does not have any negative impact on the performance of networks and has a very low packet loss rate.

As to the feature of simplicity and efficiency, the proposed solution designs SDDL to express security-related data in different network contexts with effective algorithms for processing the described data. In other word, SDDL-XML files as proposed in the present disclosure can provide information about the data needed for detecting network attacks, intrusions and threats. According to the contents of the XML file, corresponding data collectors can be triggered to collect security-related data needed in the underlying network context. Later data composition for security measurement can be easily conducted based on the tag marked on the collected data, which contains the algorithms used for data processing and the potential threats that can be detected. The processing procedure is precise and simple. For example, parallel data processing can be easily applied to achieve high efficiency since different security detection and measurement algorithms can be executed at the same time.

The various blocks shown in FIGS. 1-6 may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

FIG. 7 is a block diagram illustrating an apparatus 700 according to an embodiment of the present disclosure. As shown in FIG. 7, the apparatus 700 may comprise one or more processors such as processor 701 and one or more memories such as memory 702 storing computer program codes 703. The one or more memories 702 and the computer program codes 703 may be configured to, with the one or more processors 701, cause the apparatus 700 at least to perform any operation of the method as described in connection with any of FIGS. 1-2. Alternatively or additionally, the one or more memories 702 and the computer program codes 703 may be configured to, with the one or more processors 701, cause the apparatus 700 at least to perform more or less operations to implement the proposed methods according to the exemplary embodiments of the present disclosure.

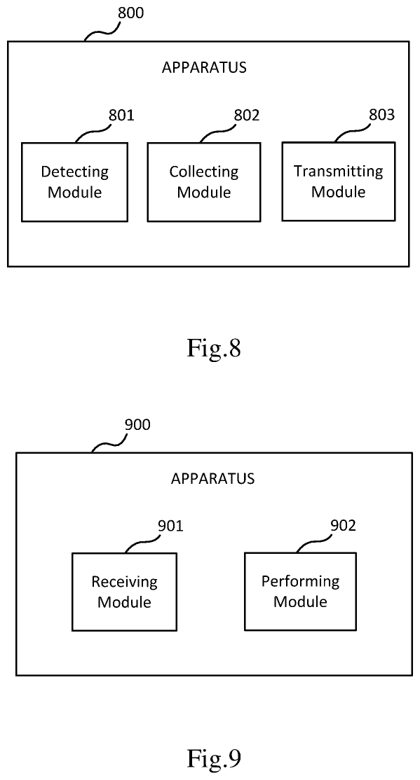

FIG. 8 is a block diagram illustrating another apparatus 800 according to another embodiment of the present disclosure. As shown in FIG. 8, the apparatus 800 may comprise a detecting module 801, a collecting module 802 and a transmitting module 803. In an exemplary embodiment, the apparatus 800 may be implemented at a communication node which is responsible for collecting network data. The detecting module 801 may be operable to carry out the operation in block 102, the collecting module 802 may be operable to carry out the operation in block 104, and the transmitting module 803 may be operable to carry out the operation in block 106. Optionally, the detecting module 801, the collecting module 802 and/or the transmitting module 803 may be operable to carry out more or less operations to implement the proposed methods according to the exemplary embodiments of the present disclosure.

FIG. 9 is a block diagram illustrating yet another apparatus according to a further embodiment of the present disclosure. As shown in FIG. 9, the apparatus 900 may comprise a receiving module 901 and a performing module 902. In an exemplary embodiment, the apparatus 900 may be implemented at a server for data composition. The receiving module 901 may be operable to carry out the operation in block 202, and the performing module 902 may be operable to carry out the operation in block 204. In an exemplary embodiment, the apparatus 900 may further comprise a measuring module (not shown in FIG. 9) which may be operable to measure a security level for a network. Optionally, the receiving module 901, the performing module 902 and/or the measuring module may be operable to carry out more or less operations to implement the proposed methods according to the exemplary embodiments of the present disclosure.

In general, the various exemplary embodiments may be implemented in hardware or special purpose silicon chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

What is claimed is:

1. A method, comprising:
detecting a network context for a communication node;
collecting network data for the communication node based at least in part on policy information associated with the network context, wherein the policy information describes a collection policy for the network data; and
transmitting at least part of the collected network data and a tag derived from the policy information to a server for data composition.

2. The method according to claim 1, wherein the collection policy indicates one or more collection schemes for the network data according to a category of the network data.

3. The method according to claim 1 or 2, wherein the policy information indicates one or more instructions for pre-processing the collected network data to obtain the at least part of the collected network data.

4. The method according to any one of claims 1 to 3, wherein the policy information is described in a markup language.

5. The method according to any one of claims 1 to 4, wherein the policy information comprises at least one of the following information elements for the network data:
a network type;
a network protocol;
a data location;
a data category;
a data importance level;
a collection priority;
a data length;
a storage type;
a collector identification; and
a composition tag.

6. The method according to any one of claims 1 to 5, wherein the tag indicates one or more data composition algorithms for the at least part of the collected network data.

7. The method according to any one of claims 1 to 6, wherein the tag indicates one or more security threats related to the at least part of the collected network data.

8. The method according to any one of claims 1 to 7, wherein the tag indicates collection time of the network data.

9. The method according to any one of claims 1 to 8, wherein the network data comprise security-related data.

10. The method according to any one of claims 1 to 9, wherein the tag is attached to the at least part of the collected network data as metadata.

11. An apparatus, comprising:
at least one processor; and
at least one memory comprising computer program code,
the at least one memory and the computer program code configured to, with the at least one processor, cause the apparatus to perform at least the following:
detecting a network context for the apparatus;
collecting network data for the apparatus based at least in part on policy information associated with the network context, wherein the policy information describes a collection policy for the network data; and
transmitting at least part of the collected network data and a tag derived from the policy information to a server for data composition.

12. The apparatus according to claim 11, wherein the collection policy indicates one or more collection schemes for the network data according to a category of the network data.

13. The apparatus according to claim 11 or 12, wherein the policy information indicates one or more instructions for pre-processing the collected network data to obtain the at least part of the collected network data.

14. The apparatus according to any one of claims 11 to 13, wherein the policy information is described in a markup language.

15. The apparatus according to any one of claims 11 to 14, wherein the policy information comprises at least one of the following information elements for the network data:
a network type;
a network protocol;
a data location;
a data category;
a data importance level;
a collection priority;
a data length;
a storage type;
a collector identification; and
a composition tag.

16. The apparatus according to any one of claims 11 to 15, wherein the tag indicates one or more data composition algorithms for the at least part of the collected network data.

17. The apparatus according to any one of claims 11 to 16, wherein the tag indicates one or more security threats related to the at least part of the collected network data.

18. The apparatus according to any one of claims 11 to 17, wherein the tag indicates collection time of the network data.

19. The apparatus according to any one of claims 11 to 18, wherein the network data comprise security-related data.

20. The apparatus according to any one of claims 11 to 19, wherein the tag is attached to the at least part of the collected network data as metadata.

21. An apparatus, comprising:
a detecting module for detecting a network context for the apparatus;
a collecting module for collecting network data for the apparatus based at least in part on policy information associated with the network context, wherein the policy information describes a collection policy for the network data; and
a transmitting module for transmitting at least part of the collected network data and a tag derived from the policy information to a server for data composition.

22. A method, comprising:
receiving network data and a tag at a server, wherein the network data are collected for a communication node based at least in part on policy information associated with a network context of the communication node, and wherein the policy information describes a collection policy for the network data and the tag is derived from the policy information;
performing data composition of the network data based at least in part on the tag.

23. The method according to claim 22, wherein the collection policy indicates one or more collection schemes for the network data according to a category of the network data.

24. The method according to claim 22 or 23, wherein the policy information is described in a markup language.

25. The method according to any one of claims 22 to 24, wherein the policy information comprises at least one of the following information elements for the network data:
a network type;
a network protocol;
a data location;
a data category;
a data importance level;
a collection priority;
a data length;
a storage type;
a collector identification; and
a composition tag.

26. The method according to any one of claims 22 to 25, wherein the tag indicates one or more data composition algorithms for the network data.

27. The method according to any one of claims 22 to 26, wherein the tag indicates collection time of the network data.

28. The method according to any one of claims 22 to 27, wherein the tag indicates one or more security threats related to the network data.

29. The method according to any one of claims 22 to 28, wherein the tag is attached to the network data as metadata.

30. The method according to any one of claims 22 to 29, wherein the network data comprise security-related data, and wherein the method further comprises:
measuring a security level for a network with the network context based at least in part on the security-related data and the tag.

31. The method according to any one of claims 22 to 30, wherein performing data composition of the network data based at least in part on the tag comprises:
applying one or more processing algorithms indicated by the tag to the network data; and
aggregating respective outputs of the one or more processing algorithms to obtain a result of the data composition.

32. An apparatus, comprising:
at least one processor; and
at least one memory comprising computer program code,
the at least one memory and the computer program code configured to, with the at least one processor, cause the apparatus to perform at least the following:
receiving network data and a tag, wherein the network data are collected for a communication node based at least in part on policy information associated with a network context of the communication node, and wherein the policy information describes a collection policy for the network data and the tag is derived from the policy information;
performing data composition of the network data based at least in part on the tag.

33. The apparatus according to claim 32, wherein the collection policy indicates one or more collection schemes for the network data according to a category of the network data.

34. The apparatus according to claim 32 or 33, wherein the policy information is described in a markup language.

35. The apparatus according to any one of claims 32 to 34, wherein the policy information comprises at least one of the following information elements for the network data:
a network type;
a network protocol;
a data location;
a data category;
a data importance level;
a collection priority;
a data length;
a storage type;
a collector identification; and
a composition tag.

36. The apparatus according to any one of claims 32 to 35, wherein the tag indicates one or more data composition algorithms for the network data.

37. The apparatus according to any one of claims 32 to 36, wherein the tag indicates collection time of the network data.

38. The apparatus according to any one of claims 32 to 37, wherein the tag indicates one or more security threats related to the network data.

39. The apparatus according to any one of claims 32 to 38, wherein the tag is attached to the network data as metadata.

40. The apparatus according to any one of claims 32 to 39, wherein the network data comprise security-related data, and wherein the at least one memory and the computer program code are configured to, with the at least one processor, cause the apparatus further to perform:
measuring a security level for a network with the network context based at least in part on the security-related data and the tag.

41. The apparatus according to any one of claims 32 to 40, wherein performing data composition of the network data based at least in part on the tag comprises:
applying one or more processing algorithms indicated by the tag to the network data; and
aggregating respective outputs of the one or more processing algorithms to obtain a result of the data composition.

42. An apparatus, comprising:
a receiving module for receiving network data and a tag, wherein the network data are collected for a communication node based at least in part on policy information associated with a network context of the communication node, and wherein the policy information describes a collection policy for the network data and the tag is derived from the policy information;
a performing module for performing data composition of the network data based at least in part on the tag.

43. A computer program product comprising a computer-readable medium bearing computer program codes embodied therein for use with a computer, wherein the computer program codes comprise codes for performing the method according to any one of claims 1-10 and claims 22-31.
